(19) United States
(12) Patent Application Publication
(10) Pub. No.: US 2022/0083272 A1
(43) Pub. Date: Mar. 17, 2022

(54) INFORMATION PROCESSING APPARATUS, COMPUTER-READABLE RECORDING MEDIUM STORING PROGRAM, AND METHOD OF PROCESSING INFORMATION

(71) Applicant: FUJITSU LIMITED, Kawasaki-shi (JP)

(72) Inventor: Satoshi Imamura, Kawasaki (JP)

(73) Assignee: FUJITSU LIMITED, Kawasaki-shi (JP)

(21) Appl. No.: 17/336,368

(22) Filed: Jun. 2, 2021

(30) Foreign Application Priority Data
Sep. 15, 2020 (JP) 2020-154674

(51) Int. Cl. G06F 3/06

(52) U.S. Cl. CPC G06F 3/0659; G06F 3/0604; G06F 3/0634; G06F 3/068; G06F 3/0653; G06F 3/064

(57) ABSTRACT

An information processing apparatus includes: a processor; a first memory that is volatile and is coupled to the processor; a block device that is coupled to the processor; and at least one second memory that is nonvolatile, is coupled to the processor and that is configured to function as the first memory and the block device, and the processor controls a write method of the at least one second memory that functions as the block device in accordance with a usage status of the first memory so as to switch the function as the block device to the function as the first memory in the at least one second memory.

### CROSS-REFERENCE TO RELATED APPLICATION

This application is based upon and claims the benefit of priority of the prior Japanese Patent Application No. 2020-154674, filed on Sep. 15, 2020, the entire contents of which are incorporated herein by reference.

### FIELD

The embodiment discussed herein is related to a processor, an information processing apparatus, a computer-readable recording medium storing a program, and a method of processing a program and information.

### BACKGROUND

As a main memory in a server, a persistent memory (PMEM) may be used. Since the PMEM is nonvolatile similarly to a solid-state drive (SSD) or a hard disk drive (HDD), the PMEM is also usable as a persistent storage.

Japanese Laid-open Patent Publication No. 2017-130194 is disclosed as related art.

### SUMMARY

According to an aspect of the embodiments, an information processing apparatus includes: a processor; a first memory that is volatile and is coupled to the processor; a block device that is coupled to the processor; and at least one second memory that is nonvolatile, is coupled to the processor and that is configured to function as the first memory and the block device, and the processor controls a write method of the at least one second memory that functions as the block device in accordance with a usage status of the first memory so as to switch the function as the block device to the function as the first memory in the at least one second memory.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram schematically illustrating an example of a hardware configuration of an information processing apparatus according to an example of the embodiment;

FIG. 2 is a block diagram illustrating a switching process of a PMEM illustrated in FIG. 1;

FIG. 3 is a flowchart explaining a function switching process of the PMEM according to the example of the embodiment;

FIG. 4 is a flowchart explaining the details of a write back interval control process of PMEM storages illustrated in FIG. 3;

FIG. 5 is a flowchart explaining the details of a deallocation process of PMEM devices illustrated in FIG. 3;

FIG. 6 is a flowchart explaining the details of an allocation process of the PMEM devices illustrated in FIG. 3;

FIG. 7 is a flowchart explaining the function switching process of the PMEM according to a modification example;

FIG. 8 is a flowchart explaining the details of a write method control process of the PMEM storages illustrated in FIG. 7; and

FIG. 9 is a flowchart explaining the details of the allocation process of the PMEM devices illustrated in FIG. 7.

### DESCRIPTION OF EMBODIMENTS

The PMEM may be used as the main memory or the persistent storage in accordance with a usage status of the system. For example, when the memory capacity is insufficient, the PMEM is used as the main memory. Thus, the memory capacity is increased. In contrast, when load of the SSD or the HDD is high, the PMEM is used as the persistent storage. Thus, the input/output (I/O) performance is improved.

However, delay may occur in a function switching process from the persistent storage to the main memory due to a write back process for the dirty data in the PMEM.

In one aspect, overhead in switching the function of the PMEM may be reduced.

### [A] Embodiment

Hereinafter, an embodiment will be described with reference to the drawings. It is noted that the following embodiment is merely exemplary and not intended to exclude various modification examples and technical applications which are not explicitly described in the embodiment. For example, the present embodiment may be implemented with various modifications without departing from the gist of the present embodiment. Each of the drawings is not intended to indicate that only the drawn elements are provided, and the embodiment may include other functions and so on.

Since the same reference signs indicate the same elements in the drawings, the description thereof will be omitted below.

### [A-1] Configuration Example

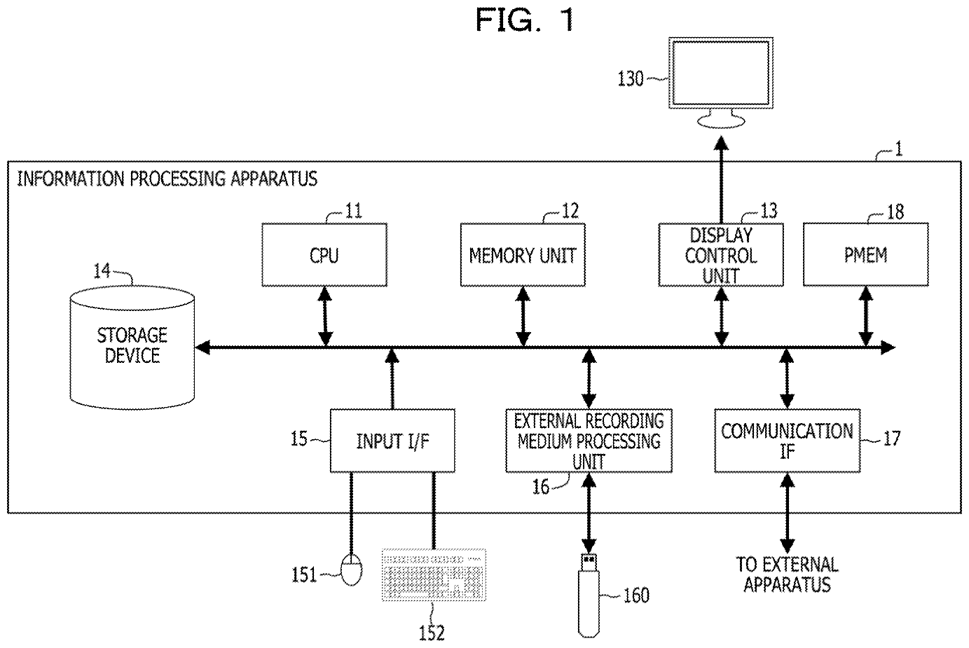

FIG. 1 is a block diagram schematically illustrating an example of a hardware configuration of an information processing apparatus 1 according to an example of the embodiment.

As illustrated in FIG. 1, the information processing apparatus 1 has a server function and includes a central processing unit (CPU) 11, a memory unit 12, a display control unit 13, a storage device 14, an input interface (I/F) 15, an external recording medium processing unit 16, a communication I/F 17, and persistent memories (PMEMs) 18.

The memory unit 12 is an example of a storage unit and includes, for example, a read-only memory (ROM), a random-access memory (RAM), and so on. Programs such as a Basic Input/Output System (BIOS) may be written in the ROM of the memory unit 12. The software programs stored in the memory unit 12 may be appropriately loaded into and executed by the CPU 11. The RAM of the memory unit 12 may be used as a memory for temporary recording or as a working memory.

The display control unit 13 is coupled to a display device 130 and controls the display device 130. The display device 130 is a liquid crystal display, an organic light-emitting diode (OLED) display, a cathode ray tube (CRT), an electronic paper display, or the like and displays various types of information for an operator or the like. The display device 130 may be combined with an input device. For example, the display device 130 may be a touch panel.

The storage device 14 is a storage device with high IO performance. For example, dynamic random-access memory (DRAM), a solid-state drive (SSD), storage class memory (SCM), or a hard disk drive (HDD) may be used as the storage device 14.

The input I/F 15 may be coupled to input devices such as a mouse 151 and a keyboard 152 and control the input devices such as the mouse 151 and the keyboard 152. The mouse 151 and the keyboard 152 are examples of the input device. The operator performs various input operations by using these input devices.

The external recording medium processing unit 16 is configured so that a recording medium 160 is attachable thereto. The external recording medium processing unit 16 is configured to be able to read information recorded in the recording medium 160 in a state in which the recording medium 160 is attached thereto. In the present example, the recording medium 160 is portable. For example, the recording medium 160 is a flexible disk, an optical disc, a magnetic disk, a magneto-optical disk, a semiconductor memory, or the like.

The communication I/F 17 is an interface that enables communication with an external apparatus.

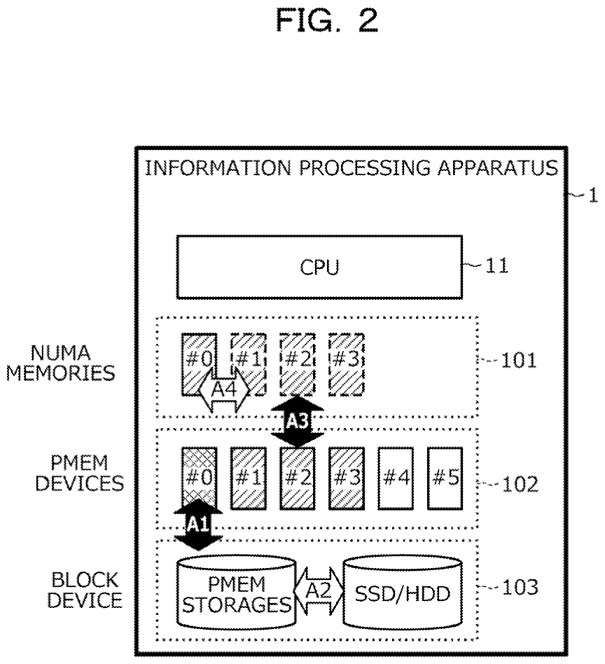

The PMEMs 18 are storage devices that are mountable in a dual inline memory module (DIMM) slots and that allow byte access thereto. The PMEMs 18 are nonvolatile storage devices in which data is not deleted when the power supply is shut down. The PMEMs 18 are able to function as a block device 103 (described later with reference to FIG. 2).

The CPU 11 is an example of a processor and is a processing device that performs various controls and operations. The CPU 11 executes an operating system (OS) and the programs loaded into the memory unit 12 to realize various functions.

The device that controls the operations of the entire information processing apparatus 1 is not limited to the CPU 11 and may be, for example, any one of a microprocessor unit (MPU), a digital signal processor (DSP), an application-specific integrated circuit (ASIC), a programmable logic device (PLD), and a field-programmable gate array (FPGA). The device that controls the operations of the entire information processing apparatus 1 may be a combination of two or more types of the CPU, the MPU, the DSP, the ASIC, the PLD, and the FPGA.

FIG. 2 is a block diagram illustrating a switching process of the PMEM illustrated in FIG. 1.

As illustrated in FIG. 2, non-uniform memory access (NUMA) memories 101, PMEM devices 102, and the block device 103 are defined in the information processing apparatus 1.

The NUMA memories 101 are examples of a first memory. A plurality of DRAM DIMMs are coupled to the NUMA memories 101. The NUMA memories 101 are recognized as a single memory by the OS. The PMEM devices 102 are examples of a second memory, and a plurality of the PMEM DIMMs are coupled to the PMEM devices 102. One or more persistent storage devices are coupled to the block device 103.

In an example illustrated in FIG. 2, as indicated by a reference numeral A1, an identifier (ID) #0 of the PMEM devices 102 functions as a PMEM storage in the block device 103. As indicated by a reference numeral A2, in the block device 103, the PMEMs 18 functioning as PMEM storages exchange data with the SSD or the HDD corresponding to the storage device 14 illustrated in FIG. 1.

As indicated by a reference numeral A3, the IDs #1 to #3 of the PMEM devices 102 function as PMEM memories in the NUMA memories 101. As indicated by a reference numeral A4, in the NUMA memories 101, the PMEMs 18 functioning as the PMEM memories exchange data with the DRAM corresponding to the memory unit 12 illustrated in FIG. 1.

In an example of the embodiment, as indicated by the reference numerals A1 and A3, the function of each of the PMEMs 18 is dynamically switched to a memory or a storage in accordance with the usage status of the system.

When the PMEMs 18 are used as the PMEM memories, data management is performed by a NUMA management function included in the OS. When DRAM capacity is insufficient, memory is secured from the PMEM memories. Data migration is performed between the DRAM and the PMEM memories.

When the PMEMs 18 are used as the PMEM storages, the PMEMs 18 function as a persistent cache of the SSD or the HDD.

Use of the PMEMs 18 as the PMEM memories may be given priority over the use of the PMEMs 18 as the PMEM storages. When memory capacity is likely to become insufficient, the function of the PMEM storages is switchable to that of the PMEM memories even during the use of the PMEM storages. In contrast, the PMEM memories in use are not switchable to the PMEM storages.

The reason why the use of the PMEMs 18 as the PMEM memories is given priority over the use as the PMEM storages as described above is that an application is significantly influenced when the memory capacity is insufficient. For example, when a swap area is usable, the performance of the application is significantly degraded by a swap process. In contrast, when the swap area is unusable, execution of the application is interrupted. When the PMEM storages are not usable, the performance of the application is only slightly degraded.

In the case where the memory capacity is likely to become insufficient, when the function of the PMEMs 18 is switched from the PMEM storages to the PMEM memories, dirty data in the PMEM storages used as the persistent cache is written back to the SSD or the HDD. Accordingly, when the amount of dirty data is large, it takes a long time to execute a write back process, and the switching process is not necessarily completed before timing at which the memory capacity actually becomes insufficient.

Thus, according to the example of the embodiment, a time interval of the write back process of the PMEM storages is set to be small so as to reduce the amount of dirty data in the PMEM storages.

The CPU 11 controls a write method of the PMEM devices 102 functioning as the block device 103 in accordance with a usage status of the NUMA memories 101. The CPU 11 switches the function as the block device 103 in the PMEM devices 102 to the function as the NUMA memories 101.

The CPU 11 may control the write method when there is a NUMA memory 101 in which, as the usage status, the possibility that the memory capacity becomes insufficient is greater than a first threshold. The control of the write method may be performed by reducing the time interval of the write back process to the block device 103 in a PMEM device 102 the usage rate of which is the lowest among the PMEM devices 102 functioning as the block device 103.

When there is the NUMA memory 101 in which, as the usage status, the possibility that the memory capacity becomes insufficient is greater than the first threshold, the CPU 11 may perform a deallocation process of the PMEM device 102. The deallocation process may be performed by, in the PMEM device 102 which functions as the block device 103 and the usage rate of which is 0 within a predetermined period of time, writing back the data to the block device 103 and deallocating the function as the block device 103.

When there is the NUMA memory 101 in which, as the usage status, the possibility that the memory capacity becomes insufficient is greater than a second threshold that is higher than the first threshold and there is no PMEM device 102 in an unallocated state, the CPU 11 may perform the switching process of the PMEM devices 102. The switching process may be performed by switching the function as the block device 103 to the function as the NUMA memory 101 in the PMEM devices 102 having undergone the control of the write method.

### [A-2] Operation Example

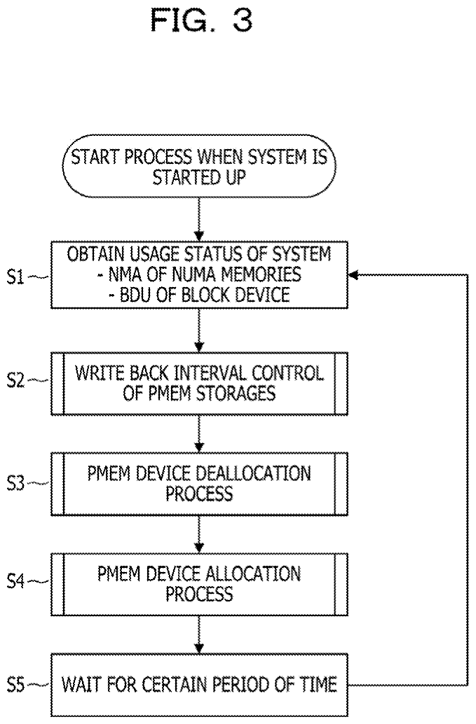

A function switching process of the PMEM according to the example of the embodiment will be described in accordance with a flowchart (steps S1 to S5) illustrated in FIG. 3.

Processing is started when the system is started up, and a NUMA memory allocation (NMA) of the NUMA memories 101 and a block device utilization (BDU) of the block device 103 are obtained as the usage status of the system (step S1). The NMA may be referred to as a NUMA memory allocation rate and is a value obtained by dividing the allocated capacity of each of memories functioning as the NUMA memories 101 by the total capacity of the NUMA memories 101. The BDU may be referred to as a block device usage rate and is a value indicating a ratio of a period of usage time per unit period of time of each of the storages that functions as the block device 103.

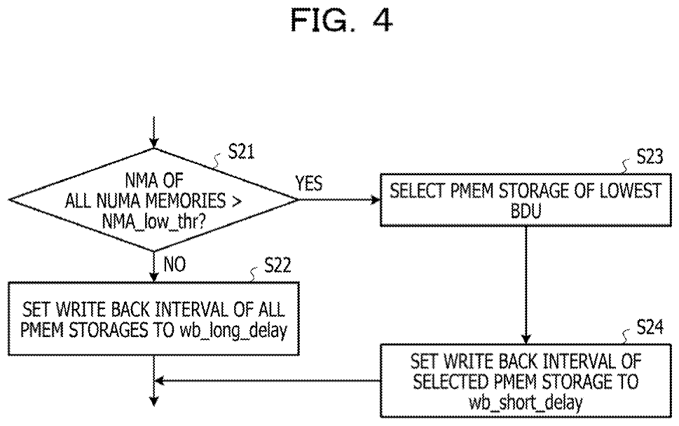

The write back interval control of the PMEM storages is performed (step S2). The details of the process in step S2 will be described later with reference to FIG. 4.

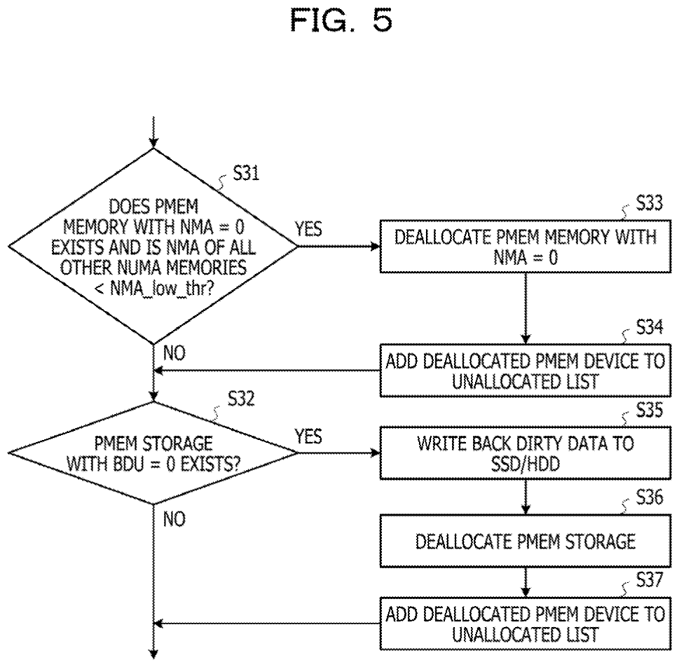

The deallocation process of the PMEM devices 102 is performed (step S3). The details of the process in step S3 will be described later with reference to FIG. 5.

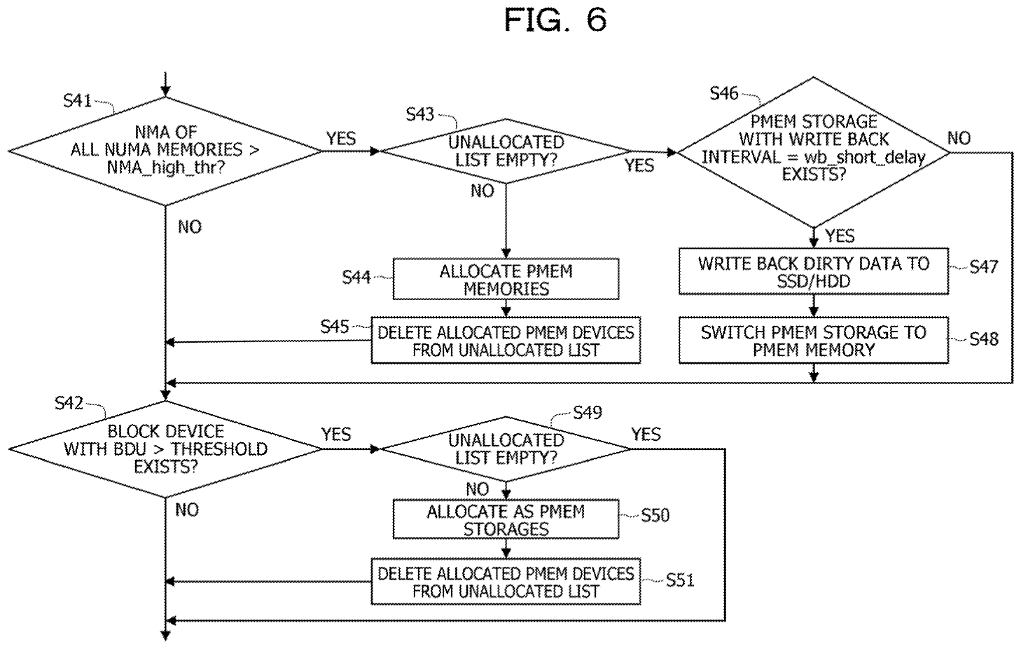

An allocation process of the PMEM devices 102 is performed (step S4). The details of the process in step S4 will be described later with reference to FIG. 6.

After waiting for a certain period of time (step S5), the processing returns to step S1.

Next, the details of the write back interval control process of the PMEM storages illustrated in FIG. 3 will be described in accordance with a flowchart (steps S21 to S24) illustrated in FIG. 4.

It is determined whether the NMA of all the memories included in the NUMA memories 101 is greater than NMA_low_thr (step S21). NMA_low_thr is an example of the first threshold and is a threshold of the NMA for determining that the memory capacity is likely to become insufficient.

When the NMA of at least a subset of the memories included in the NUMA memories 101 is smaller than or equal to NMA_low_thr (see the NO route in step S21), the time interval of the write back process of all the PMEM storages is set to wb_long_delay (step S22). The write back interval control process of the PMEM storages ends.

In contrast, when the NMA of all the memories included in the NUMA memories 101 is greater than NMA_low_thr (see the YES route in step S21), the PMEM storage the BDU of which is the lowest is selected (step S23).

The time interval of the write back process of the selected PMEM storage is set to wb_short_delay (step S24). The write back interval control process of the PMEM storage ends. The time interval wb_short_delay of the write back process is smaller than wb_long_delay.

Next, the details of the deallocation process of the PMEM devices 102 illustrated in FIG. 3 will be described in accordance with a flowchart (steps S31 to S37) illustrated in FIG. 5.

It is determined whether there is a PMEM memory the NMA of which is 0 and the NMA of all the memories included in the other NUMA memories 101 is smaller than NMA_low_thr (step 931).

When there is no PMEM memory the NMA of which is 0 or the NMA of all the memories included in the other NUMA memories 101 is greater than or equal to NMA_low_thr (see the NO route in step S31), it is determined whether there is the PMEM storage the BDU of which is 0 within a predetermined period of time (step S32).

When there is no PMEM storage the BDU of which is 0 (see the NO route in step S32), the deallocation process of the PMEM devices 102 ends.

When, in step 931, there is the PMEM memory the NMA of which is 0 and the NMA of all the memories included in the other NUMA memories 101 is smaller than NMA_low_thr (see the YES route in step S31), the PMEM memory the NMA of which is 0 is deallocated (step S33).

The deallocated PMEM device 102 is added to an unallocated list (step 934), and the processing proceeds to step 932. The unallocated list stores the IDs of the PMEM devices 102 in an unallocated state. In the example illustrated in FIG. 1, in the PMEM devices 102, the PMEMs 18 [#4, #5] allocated to neither the NUMA memories 101 nor the block device 103 are stored.

In step S32, when there is the PMEM storage the BDU of which is 0 (see the YES route in step S32), dirty data is written back from the PMEM storage to the SSD or the HDD (step S35).

The PMEM storage is deallocated (step S36).

The deallocated PMEM device 102 is added to the unallocated list (step S37). The deallocation process of the PMEM device 102 ends.

Next, the details of the allocation process of the PMEM devices 102 illustrated in FIG. 3 will be described in accordance with a flowchart (steps S41 to S51) illustrated in FIG. 6.

It is determined whether the NMA of all the NUMA memories 101 is greater than NMA_high_thr (step S41). NMA_high_thr is an example of the second threshold, a threshold of the NMA for determining that the memory capacity is likely to become insufficient, and greater than NMA_low_thr.

When the NMA 18 of at least a subset of the NUMA memories 101 is smaller than or equal to NMA_high_thr (see the NO route in step S41), it is determined whether there is a storage of the block device 103 the BDU of which is greater than the threshold (step S42).

When there is no storage of the block device 103 the BDU of which is greater than the threshold (see the NO route in step S42), the allocation process of the PMEM devices 102 ends.

In step S41, when the NMA of all the NUMA memories 101 is greater than NMA_high_thr (see the YES route in step S41), it is determined whether the unallocated list is empty (step S43).

When the unallocated list is not empty (see the NO route in step S43), the PMEM devices 102 are allocated as the PMEM memories (step S44).

The allocated PMEM devices 102 are deleted from the unallocated list (step S45). The processing proceeds to step S42.

In step S43, when the unallocated list is empty (see the YES route in step S43), it is determined whether there is the PMEM storage the time interval of the write back process for which is wb_short_delay (step S46).

When there is no PMEM storage the time interval of the write back process for which is wb_short_delay (see the NO route in step S46), the processing proceeds to step S42.

In contrast, when there is the PMEM storage the time interval of the write back process for which is wb_short_delay (see the YES route in step S46), dirty data is written back from the PMEM storage to the SSD or the HDD (step S47).

The PMEM storage is switched to the PMEM memory (step S48). The processing proceeds to step S42.

In step S42, when there is the storage of the block device 103 the BDU of which is greater than the threshold (see the YES route in step S42), it is determined whether the unallocated list is empty (step S49).

When the unallocated list is empty (see the YES route in step S49), the allocation process of the PMEM devices 102 ends.

In contrast, when the unallocated list is not empty (see the NO route in step S49), the PMEM devices 102 are allocated as the PMEM storages (step S50).

The allocated PMEM devices 102 are deleted from the unallocated list (step S51). The allocation process of the PMEM devices 102 ends.

### [B] Modification Example

Although the time interval of the write back process of the PMEM storages is set to be small so as to reduce the amount of dirty data in the PMEM storage according to the above-described example of the embodiment, this in not limiting.

The updated data may be simultaneously written to the PMEM storages and the SSD or the HDD by switching the write method of the PMEM storages to write through. This sets all the data in the PMEM storages in an updated state (for example, a clean state). Accordingly, the dirty data in the PMEM storages may be reduced.

For example, the CPU 11 may control the write method when there is the NUMA memory 101 in which, as the usage status, the possibility that the memory capacity becomes insufficient is greater than the first threshold. The control of the write method may be performed by writing through to the block device 103 the data for the PMEM device 102 the usage rate of which is the lowest among the PMEM devices 102 functioning as the block device 103.

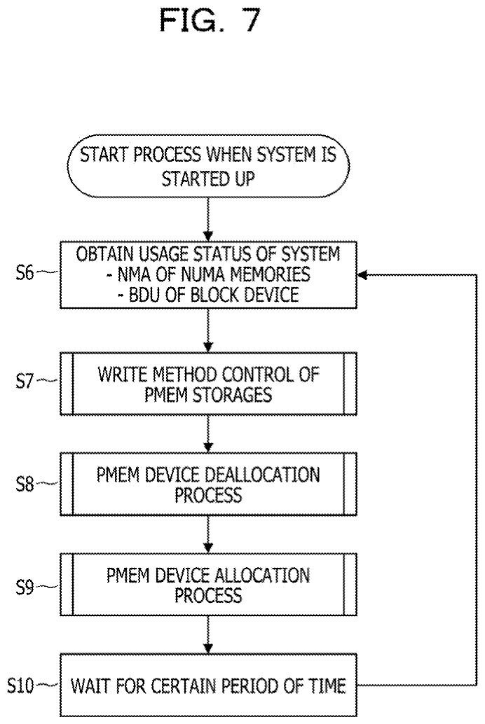

The function switching process of the PMEM according to the modification example will be described in accordance with a flowchart (steps S6 to S10) illustrated in FIG. 7.

Processing is started when the system is started up, and the NMA of the NUMA memories 101 and the BDU of the block device 103 are obtained as the usage status of the system (step S6).

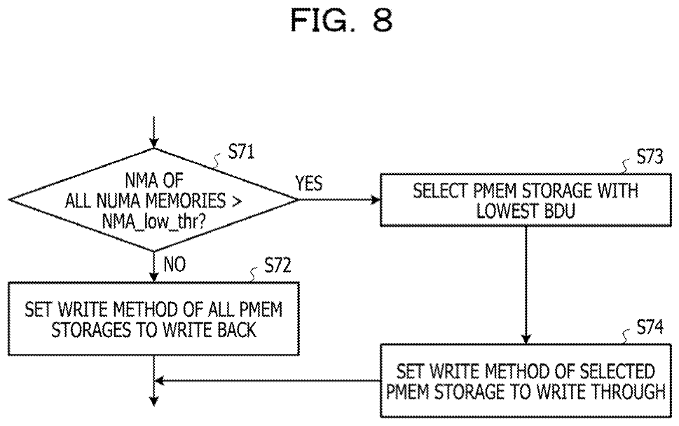

The write method control of the PMEM storages is performed (step S7). The details of the process in step S7 will be described later with reference to FIG. 8.

The deallocation process of the PMEM devices 102 is performed (step S8). The details of a process in step S8 are similar to the process in the example of the embodiment having been described with reference to FIG. 5.

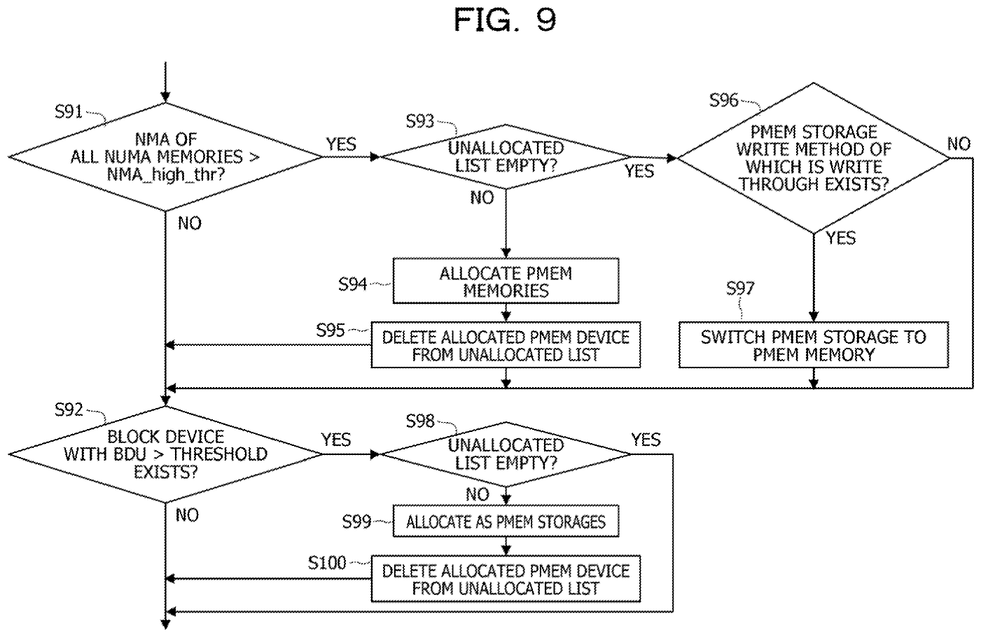

The allocation process of the PMEM devices 102 is performed (step S9). The details of the process in step S4 will be described later with reference to FIG. 9.

After waiting for a certain period of time (step S10), the processing returns to step S6.

Next, the details of the write method control process of the PMEM storages illustrated In FIG. 7 will be described in accordance with a flowchart (steps S71 to S74) illustrated in FIG. 8.

It is determined whether the NMA of all the memories included in the NUMA memories 101 is greater than NMA_low_thr (step S71).

When the NMA of at least a subset of the memories included in the NUMA memories 101 is smaller than or equal to NMA_low_thr (see the NO route in step S71), the write method of all the PMEM storages is set to the write back (step S72). The write method control process of the PMEM storages ends.

In contrast, when the NMA of all the memories included in the NUMA memories 101 is greater than NMA_low_thr (see the YES route in step S71), the PMEM storage the BDU of which is the lowest is selected (step S73).

The write method for the selected PMEM storage is set to the write through (step S74). The write method control process of the PMEM storages ends.

Next, the details of the allocation process of the PMEM devices 102 illustrated in FIG. 7 will be described in accordance with a flowchart (steps S91 to S100) illustrated in FIG. 9.

It is determined whether the NMA of all the NUMA memories 101 is greater than NMA_high_thr (step S91).

When the NMA 18 of at least a subset of the NUMA memories 101 is smaller than or equal to NMA_high_thr (see the NO route in step S91), it is determined whether there is a storage of the block device 103 the BDU of which is greater than the threshold (step S92).

When there is no storage of the block device 103 the BDU of which is greater than the threshold (see the NO route in step S92), the allocation process of the PMEM devices 102 ends.

In step S91, when the NMA of all the NUMA memories 101 is greater than NMA_high_thr (see the YES route in step S91), it is determined whether the unallocated list is empty (step S93).

When the unallocated list is not empty (see the NO route in step S93), the PMEM devices 102 are allocated as the PMEM memories (step S94).

The allocated PMEM devices 102 are deleted from the unallocated list (step S95). The processing proceeds to step S92.

In step S93, when the unallocated list is empty (see the YES route in step S93), it is determined whether there is the PMEM storage the write method for which is the write through (step S96).

When there is no PMEM storage the write method for which is the write through (see the NO route in step S96), the processing proceeds to step S92.

In contrast, when there is the PMEM storage the write method for which is the write through (see the YES route in step S96), the PMEM storage is switched to the PMEM memory (step S97). The processing proceeds to step S92.

In step S92, when there is the storage of the block device 103 the BDU of which is greater than the threshold (see the YES route in step S92), it is determined whether the unallocated list is empty (step S98).

When the unallocated list is empty (see the YES route in step S98), the allocation process of the PMEM devices 102 ends.

In contrast, when the unallocated list is not empty (see the NO route in step S98), the PMEM devices 102 are allocated as the PMEM storages (step S99).

The allocated PMEM devices 102 are deleted from the unallocated list (step S100). The allocation process of the PMEM devices 102 ends.

### [C] Effects

With the example of the embodiment and the modification example, for example, the following effects may be obtained.

The CPU 11 controls the write method of the PMEM devices 102 functioning as the block device 103 in accordance with the usage status of the NUMA memories 101. The CPU 11 switches the function as the block device 103 to the function as the NUMA memories 101 in the PMEM devices 102.

This may reduce overhead in switching of the function of the PMEM. Flexible use of the PMEM devices 102 may be realized by increasing the memory capacity when the memory capacity is likely to become insufficient and improving the I/O performance when load of the SSD or the HDD is high.

The CPU 11 controls the write method when there is the NUMA memory 101 in which, as the usage status, the possibility that the memory capacity becomes insufficient is greater than the first threshold. The control of the write method is performed by reducing the time interval of the write back process to the block device 103 in the PMEM device 102 the usage rate of which is the lowest among the PMEM devices 102 functioning as the block device 103. Accordingly, the amount of dirty data to be written back in switching the PMEM devices 102 may be reduced, and the delay time in the switching process may be reduced.

The CPU 11 controls the write method when there is the NUMA memory 101 in which, as the usage status, the possibility that the memory capacity becomes insufficient is greater than the first threshold. The control of the write method is performed by writing through to the block device 103 the data for the PMEM device 102 the usage rate of which is the lowest among the PMEM devices 102 functioning as the block device 103. Accordingly, the amount of dirty data to be written back in switching the PMEM devices 102 may be further reduced, and the delay time in the switching process may be reduced.

When there is the NUMA memory 101 in which, as the usage status, the possibility that the memory capacity becomes insufficient is greater than the first threshold, the CPU 11 performs the deallocation process of the PMEM devices 102. The deallocation process is performed by, in the PMEM device 102 which functions as the block device 103 and the usage rate of which is 0 within a predetermined period of time, writing back the data to the block device 103 and deallocating the function as the block device 103. Accordingly, the PMEM devices 102 in the unallocated state may be secured before the memory capacity actually becomes insufficient.

When there is the NUMA memory 101 in which, as the usage status, the possibility that the memory capacity becomes insufficient is greater than the second threshold that is higher than the first threshold and there is no PMEM device 102 in the unallocated state, the CPU 11 performs the switching process of the PMEM devices 102. The switching process is performed by switching the function as the block device 103 to the function as the NUMA memory 101 in the PMEM devices 102 having undergone the control of the write method. Accordingly, the PMEM devices 102 may be allocated as the NUMA memories 101 before the memory capacity actually becomes insufficient.

### [D] Others

The disclosed technique is not limited to the above-described embodiment. The disclosed technique may be carried out with various modifications without departing from the gist of the present embodiment. The configurations and the processes of the present embodiment may be selected as desired or may be combined as appropriate.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing apparatus comprising:
a processor;
a first memory that is volatile and is coupled to the processor,
a block device that is coupled to the processor; and
at least one second memory that is nonvolatile, is coupled to the processor and that is configured to function as the first memory and the block device, wherein
the processor controls a write method of the at least one second memory that functions as the block device in accordance with a usage status of the first memory so as to switch the function as the block device to the function as the first memory in the at least one second memory.

2. The information processing apparatus according to claim 1, wherein
the at least one second memory includes a plurality of second memories, and wherein,
when there is the first memory in which, as the usage status, a possibility that a memory capacity becomes insufficient is greater than a first threshold, the write method is controlled by reducing a time interval of a write back process to the block device in a second memory among the plurality of second memories a usage rate of which is a lowest among the plurality of second memories that function as the block device.

3. The information processing apparatus according to claim 1, wherein
the at least one second memory includes a plurality of second memories, and wherein
when there is the first memory in which, as the usage status, a possibility that a memory capacity becomes insufficient is greater than a first threshold, the write method is controlled by writing through to the block device data for a second memory among the plurality of second memories a usage rate of which is a lowest among the plurality of second memories that function as the block device.

4. The information processing apparatus according to claim 1, wherein,
when there is the first memory in which, as the usage status, a possibility that a memory capacity becomes insufficient is greater than a first threshold, in the at least one second memory which functions as the block device and a usage rate of which is 0 within a predetermined period of time, data is written back to the block device and the function as the block device is deallocated.

5. The information processing apparatus according to claim 1, wherein,
the at least one second memory includes a plurality of second memories, and wherein
when there is the first memory in which, as the usage status, a possibility that a memory capacity becomes insufficient is greater than a second threshold that is higher than a first threshold, and there is not a second memory among the plurality of second memories that is allocated neither as the first memory nor as the block device, the function as the block device is switched to the function as the first memory in a second memory among the plurality of second memories the write method of which has been controlled.

6. A non-transitory computer-readable recording medium recording a program causing a computer to execute a processing of:
controlling, by a processor coupled to a first memory that is volatile, a block device and at least one second memory that is nonvolatile and is configured to function as the first memory and the block device, a write method of the at least one second memory that functions as the block device in accordance with a usage status of the first memory so as to switch the function as the block device to the function as the first memory in the at least one second memory.

7. The non-transitory computer-readable recording medium according to claim 6, wherein
the at least one second memory includes a plurality of second memories, and wherein,
when there is the first memory in which, as the usage status, a possibility that a memory capacity becomes insufficient is greater than a first threshold, the write method is controlled by reducing a time interval of a write back process to the block device in a second memory among the plurality of second memories a usage rate of which is a lowest among the plurality of second memories that function as the block device.

8. The non-transitory computer-readable recording medium according to claim 6, wherein
the at least one second memory includes a plurality of second memories, and wherein
when there is the first memory in which, as the usage status, a possibility that a memory capacity becomes insufficient is greater than a first threshold, the write method is controlled by writing through to the block device data for a second memory among the plurality of second memories a usage rate of which is a lowest among the plurality of second memories that function as the block device.

9. The non-transitory computer-readable recording medium according to claim 6, wherein,
when there is the first memory in which, as the usage status, a possibility that a memory capacity becomes insufficient is greater than a first threshold, in the at least one second memory which functions as the block device and a usage rate of which is 0 within a predetermined period of time, data is written back to the block device and the function as the block device is deallocated.

10. The non-transitory computer-readable recording medium according to claim 6, wherein,
the at least one second memory includes a plurality of second memories, and wherein
when there is the first memory in which, as the usage status, a possibility that a memory capacity becomes insufficient is greater than a second threshold that is higher than a first threshold, and there is not a second memory among the plurality of second memories that is allocated neither as the first memory nor as the block device, the function as the block device is switched to the function as the first memory in a second memory among the plurality of second memories the write method of which has been controlled.

11. A method of processing information comprising:
controlling, by a processor coupled to a first memory that is volatile, a block device and at least one second memory that is nonvolatile and is configured to function as the first memory and the block device, a write method of the at least one second memory that functions as the block device in accordance with a usage status of the first memory so as to switch the function as the block device to the function as the first memory in the at least one second memory.

12. The method of processing information according to claim 11, wherein
the at least one second memory includes a plurality of second memories, and wherein,
when there is the first memory in which, as the usage status, a possibility that a memory capacity becomes insufficient is greater than a first threshold, the write method is controlled by reducing a time interval of a write back process to the block device in a second memory among the plurality of second memories a usage rate of which is a lowest among the plurality of second memories that function as the block device.

13. The method of processing information according to claim 11, wherein
the at least one second memory includes a plurality of second memories, and wherein
when there is the first memory in which, as the usage status, a possibility that a memory capacity becomes insufficient is greater than a first threshold, the write method is controlled by writing through to the block device data for a second memory among the plurality of second memories a usage rate of which is a lowest among the plurality of second memories that function as the block device.

14. The method of processing information according to claim 11, wherein,
when there is the first memory in which, as the usage status, a possibility that a memory capacity becomes insufficient is greater than a first threshold, in the at least one second memory which functions as the block device and a usage rate of which is 0 within a predetermined period of time, data is written back to the block device and the function as the block device is deallocated.

15. The method of processing information according to claim 11, wherein,
the at least one second memory includes a plurality of second memories, and wherein
when there is the first memory in which, as the usage status, a possibility that a memory capacity becomes insufficient is greater than a second threshold that is higher than a first threshold, and there is not a second memory among the plurality of second memories that is allocated neither as the first memory nor as the block device, the function as the block device is switched to the function as the first memory in a second memory among the plurality of second memories the write method of which has been controlled.
